(19) United States
(12) Patent Application Publication
(10) Pub. No.: US 2026/0156203 A1
(43) Pub. Date: Jun. 4, 2026

(54) Hardware Communication Device

(71) Applicant: Vitesco Technologies USA, LLC, Auburn Hills, MI (US)

(72) Inventors: Nicholas Neslund, Beverly Hills, MI (US); Alex Shields, Farmington Hills, MI (US)

(73) Assignee: Vitesco Technologies USA, LLC, Auburn Hills, MI (US)

(21) Appl. No.: 18/965,093

(22) Filed: Dec. 2, 2024

(51) Int. Cl. H04L 69/08

(52) U.S. Cl. CPC H04L 69/08

(57) ABSTRACT

A communication device for translating between at least two devices, each device supporting a respective communication protocol. The communication device includes a Field Programable Gate Array (FPGA) and a first interface configured to connect to a first device. The first device supports a first communication protocol. The communication device also includes a converter in communication with the first interface and the FPGA. The converter includes a digital-to-analogue converter (DAC) and an analogue-to-digital converter (ADC). The converter receives a message from the first device by way of the first interface, then outputs the message to the FPGA for translation.

### TECHNICAL FIELD

The disclosure relates to a hardware communication device for translating between at least two protocols, each protocol supported by a device.

### BACKGROUND

Vehicles include several devices and modules that rely on one or more communication technologies to facilitate information sharing between them. A communication protocol is a collection of guiding principles that specify how two or more devices, such as two or more vehicle devices, communicate with one another. These guiding principles control several aspects of communications, such as, but not limited to, the order of the data, the structure of the data, error-checking procedure, data rate, and identification of the transmitting and receiving device. In some cases, the vehicle includes more than one communication protocol. Therefore, it is desirable to have a hardware translation device that is easily configurable and can translate between the different protocols allowing the different devices and modules to communicate with each other.

### SUMMARY

One aspect of the disclosure provides a communication device for translating messages between at least two devices. Each device supports a respective communication protocol. The communication device includes a Field Programable Gate Array (FPGA) and a first interface configured to connect to a first device. The first device supports a first communication protocol. Additionally, the communication device includes a converter in communication with the first interface and the FPGA. The converter includes a digital-to-analogue converter (DAC) and an analogue-to-digital converter (ADC). The converter receives a message from the first device by way of the first interface, then outputs a converted message to the FPGA for translation.

Implementations of this aspect of the disclosure may include one or more of the following optional features. In some implementations, the FPGA receives the converted message from the converter in a first protocol, processes the converted message, and outputs a processed message. In this case, the processed message is in a second protocol different from the first protocol.

In some implementations, the communication device further includes a daughter card in communication with the FPGA. Additionally, the communication device includes a second interface in communication with the FPGA. The second interface is configured to connect to a second device and supports a second communication protocol different from the first communication protocol. The FPGA receives a message from the daughter card in the second communication protocol, processes the received message, and outputs a processed message to the converter. In this case, the processed message is in the first communication protocol.

In some examples, when the converter receives the processed message from the FPGA, the DAC converts the processed message to an analogue message. In addition, when the converter receives the message from the first device, the ADC converts the received message to a digital message.

In some implementations, during a configuration phase, the FPGA is connected to a computing device. The computing device is configured to program the FPGA to translate data from the first communication protocol to a second communication protocol and vice versa.

Another aspect of the disclosure provides a method for translating messages between at least two devices. Each device supports a respective communication protocol. The method includes providing a Field Programable Gate Array (FPGA) and providing a first interface configured to connect to a first device. The first device supports a first communication protocol. The method also includes providing a converter in communication with the first interface and the FPGA. The converter includes a digital-to-analogue converter (DAC) and an analogue-to-digital converter (ADC). The method also includes receiving, at the converter, a message from the first device by way of the first interface. The method includes outputting the message to the FPGA for translation.

Implementations of this aspect of the disclosure may include one or more of the following optional features. In some implementations, the method further includes receiving, at the FPGA, the message from the converter in a first protocol, and processing, at the FPGA, the message. The method also includes outputting, from the FPGA, the processed message, the processed message being in a second protocol.

In some examples, communication device includes a second interface in communication with the FPGA. The second interface is configured to connect to a second device and supports a second communication protocol different from the first communication protocol. The method may also include receiving, at the FPGA, the message from a daughter card in the second communication protocol, and processing, at the FPGA, the message. The daughter card being in communication with the FPGA and the second interface. The method also includes outputting, from the FPGA, the processed message to the converter, where the processed message is in the first communication protocol.

In some implementations, when the converter receives the message from the FPGA, the DAC converts the received message to an analogue message. Additionally, when the converter receives a message from the first device, the ADC converts the received message to a digital message.

In some examples, during a configuration phase, the FPGA is connected to a computing device. The computing device is configured to program the FPGA to translate data from the first communication protocol to a second communication protocol and vice versa.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary communication device.

FIG. 2 is a schematic view of the exemplary communication device of FIG. 1 connected to multiple devices.

FIG. 3A is a schematic view of an exemplary configuration phase.

FIG. 3B is a schematic view of an exemplary execution phase.

FIG. 4 is a schematic view of an exemplary method for translating communication messages between two or more devices.

Like reference symbols in the various drawings indicate like elements.

### DETAILED DESCRIPTION

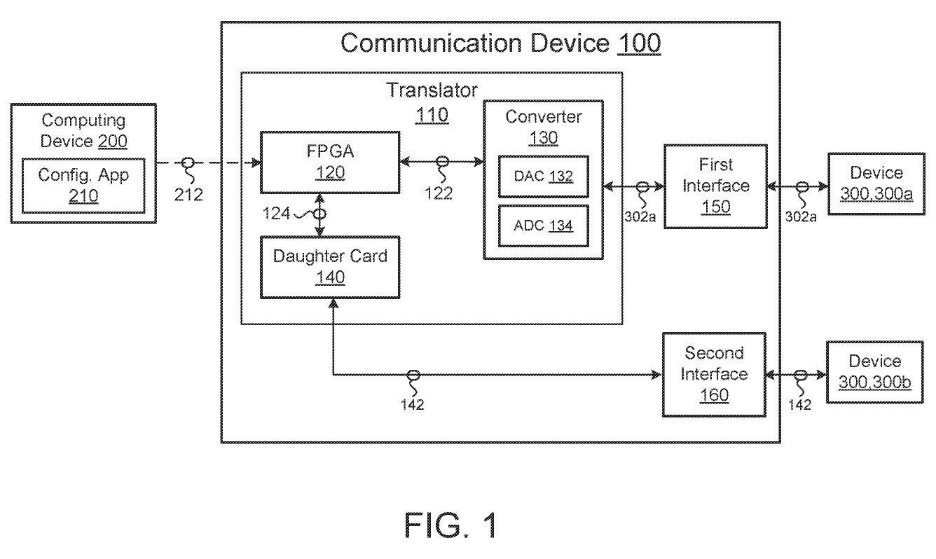

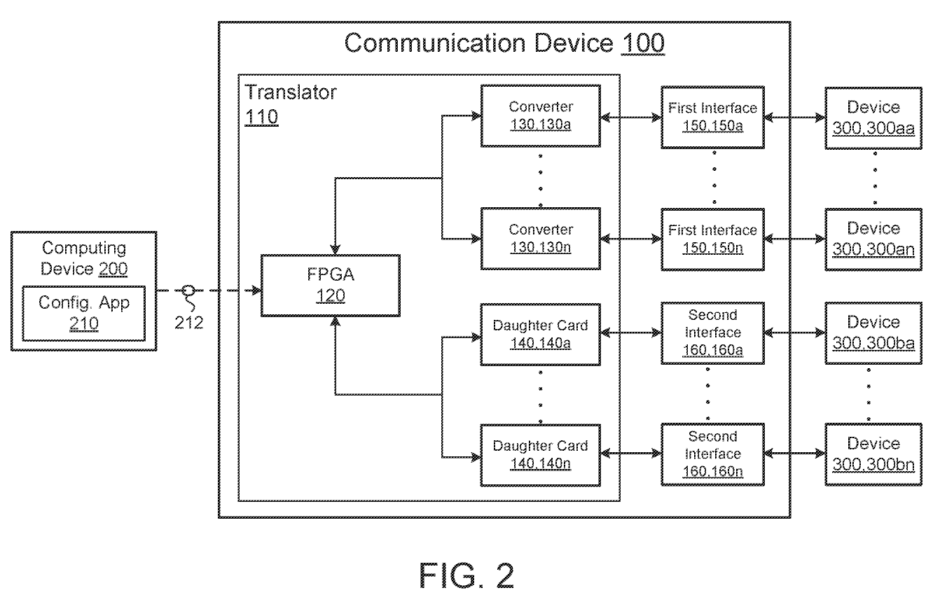

Referring to FIGS. 1 and 2, a communication device 100 is configured to bi-directionally translate between at least two protocols, where each protocol is adopted by a device 300, 300aa–300bn. The communication device 100 may be expandable to simultaneously translate between multiple devices 300, 300aa–300bn during an execution phase as shown in FIG. 2. The communication device 100 includes a translator 110. The translator 110 includes a Field Programable Gate Array (FPGA) 120, a converter 130, and optionally a daughter card 140. In some examples, a computing hardware device 200 is connected to the FPGA 120 to configure the FPGA 120 during a configuration phase.

The FPGA 120 is a configurable integrated circuit (IC) that can be programed several times. Therefore, the communication device 100 may be configured more than once to translate messages/data between different protocols. The configuration of the FPGA 120 is written using a hardware description language. The FPGA 120 may be configured to perform simple combinational functions allowing for translation between two communication protocols, or the FPGA 120 may be configured to perform complex combinational functions allowing for simultaneous translation between a plurality of communication protocols. The FPGA 120 is configured to receive or output digital data/message 122. Therefore, in some examples, the digital data 122 is conditioned for protocol translation between the devices 300. Signal conditioning is the manipulation of the digital data 122 such that the data 122 can be processed by the next module. Therefore, the converter 130 and the daughter card 140 process the data 122 outputted from the FPGA 120 or outputted to the FPGA 120 (due the bi-directionality of the communication device 100).

The converter 130 is connected to the FPGA 120 and includes a digital-to-analogue converter (DAC) 132 that converts digital data 122 received from the FPGA 120 to analogue data 302. In addition, the converter 130 also includes an analogue-to-digital converter (ADC) 134 that converts analogue data 302a received from a device 300 connected to the communication device 100 into digital data 122 to be sent to the FPGA 120. The converter 130 provides digital emulation based on software and the DAC 132 and ADC 134 provide the physical interface between the FPGA 120 and the device 300, 300aa–300an.

In some implementations, the translator 110 optionally includes a daughter card 140. The daughter card 140 is a circuit board that extends the circuitry of the FPGA 120. The daughter card 140 connects directly to the FPGA 120 through board-to-board connectors to allow for ease of swapping and changing the daughter card 140 and is designed to enhance the functionality of the FPGA 120. Therefore, the daughter card 140 provides additional features and services to the FPGA 120 thus optimizing the performance of the translator 110 and increasing its capabilities and providing customization. The daughter card 140 is configured to receive data 124 from the FPGA 120 and processes the data 124. The daughter card 140 outputs processed data 142. Similarly, the daughter card 140 may receive data 142 and processes the received data 142 such that the outputted data 122 is a digital signal readable by the FPGA 120. The processed data 142 may be a digital signal. However, in some examples, the processed signal may be an analog signal.

In some implementations, the communication device 100 includes a first hardware interface 150 and a second hardware interface 160. The hardware interfaces 150, 160 provide communication ports for sending and receiving data/signals between the devices and the communication device 100. The hardware interfaces may include, but are not limited to, Universal Serial Bus (USB), High-Definition Multimedia Interface (HDMI), Ethernet, diagnostic connectors, Controller Area Network (CAN) Bus connectors. Other interfaces may also be used.

Referring to FIG. 2, in some implementations, the translator 110 includes more than one converter 130, 130a–130n and more than one first interface 150, 150a–150n. In this case, each converter 130, 130a–130n is connected to a respective first interface 150, 150a–150n. Therefore, the number of converts 130, 130a–130n is the same as the number of first interfaces 150, 150a–150n. For examples, if the translator 110 supports three converters 130, 130a–130n, then the communication device 100 includes three first interfaces 150, 150a–150n, where each converter 130, 130a–130n is connected to one first interface 150, 150a–150n.

Similarly, in some implementations, the translator 110 includes more than one daughter cards 140, 140a–140n and more than one second interface 160, 160a–160n. In this case, each daughter card 140, 140a–140n is connected to a respective second input 160, 160a–160n. Therefore, the number of daughter cards 140, 140a–140n is the same as the number of 160, 160a–160n. For example, if the translator supports three daughter cards 140, 140a–140n, then the communication device includes three second interfaces 160, 160a–160n, where each converter 130, 130a–130n is connected to one second interface 160, 160a–160n.

The computing device 200 may include, but is not limited to, a mobile computing device, such as a desktop computer, a laptop, a tablet, and a smart phone. The computing device 200 may use any of a variety of different operating systems. The computing device 200 executes a configuration application 210 for communication with the communication device 100 allowing for the computing device 200 to configure the communication device 100. The configuration application 210 may be a native configuration application that is dedicated to interfacing with the communication device 100. The computing device 200 may communicate with the communication device 100 using a more general application. A software application (i.e., a software resource) may refer to computer software that causes a computing device to perform a task. In some examples, a software application may be referred to as an “application,” an “app,” or a “program.”

The computing device 200 may include a computing device or data processing hardware (e.g., central processing unit having one or more computing processors) in communication with non-transitory memory or hardware memory (e.g., a hard disk, flash memory, random-access memory, memory hardware) capable of storing instructions executable on the computing processor(s)). In some examples, the memory is part of the processor. The memory stores instructions that when executed by the computing device cause the communication device 100 to enter into a configuration phase (FIG. 2A). In some examples, the computing device 200 is connects to the communication device 100 by way of a USB port, ethernet port, PCIe (Peripheral Component Interconnect Express), Serial Communication (UART), I2C (Inter-Integrated Circuit), or SPI (Serial Peripheral Interface). In other examples, a wireless connection may be established between the computing device 200 and the communication device 100. The wireless connection may include, but is not limited to, Wi-Fi and Bluetooth.

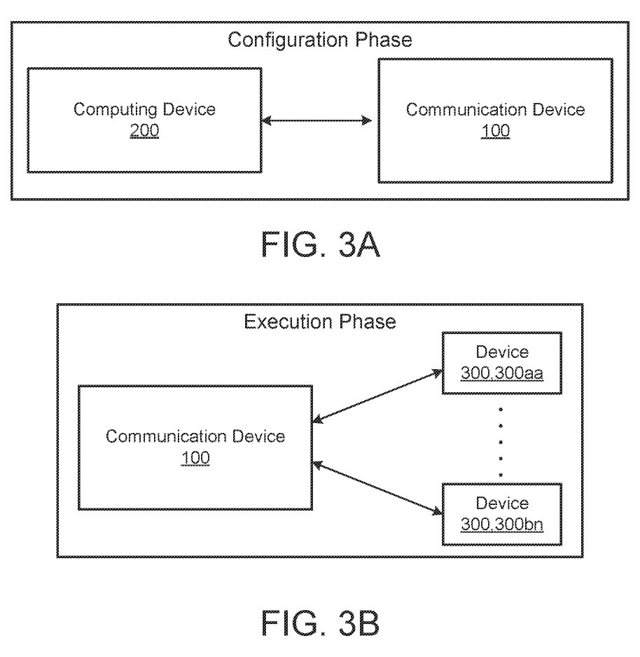

Referring to FIG. 3A, during the configuration phase, the computing device 200 is connected (wired or wirelessly) to the communication device 100. The computing device 200 configures the communication device 100 with a set of instructions that can translate one or more communication protocols to another one or more communication protocols. In some examples, the computing device 200 configures the FPGA 120 allowing it to execute the translation protocols. In some examples, the configuration phase includes configurating the communication device 100 by way of software (i.e., configuring the FPGA 120) and by way of physical elements (i.e., Daughter cards 120). For example, the communication device is physically configured by way of adding or swapping out one or more daughter cards 140 when the translator 110 is powered down and disconnected (ex. CANalyzer piggy modules). Additionally, in some examples, during the configuration phase, the FPGA 120 may configure subservient devices, such as the daughter card 140 and the converter 130. In some examples, during the configuration phase, any adjustments to a physical parameter is made, such as, but not limited to, the FPGA 120 outputting a 3.3V logic, but the converter 130 has several options, e.g., 3.3/5/12V logic, as such the FPGA sets the converter option to 3.3V.

Once the configuration phase is complete, the computing device 200 may be disconnected from the communication device 100 since the communication device 100 is ready to perform translations between several devices 300 each having a different communication protocol.

During the execution phase, the communication device 100 connects to one or more devices 300, 300aa–300bn. Each device 300, 300aa–300bn may be configured to communicate with a respective communication protocol. Therefore, the communication device 100 allows for translation between at least two devices 300, 300aa–300bn. In some examples, a device 300 may connect to the communication device 100 via the first interface 150, the second interface 160, or in some examples, via a third interface (not shown). The third interface may include a communication port being a "standardized" interface pre-provisioned on the FPGA 120 such as, but not limited to, Ethernet, wireless Ethernet, Bluetooth, USB, etc.

Referring back to FIG. 1, in some examples, during the execution phase, the translator 110 is connected to the first device 300a by way of the first interface 150. The first device 300a uses a first communication protocol. In addition, the translator 110 is also connected to the second device 300b by way of the second interface 160. The second communication device 300b uses a second communication protocol. In this case, the communication device 100 may receive data 302a from the first device 300a and translate the received data 302a from the first communication protocol to the second communication protocol supported by the second device 300b, allowing the two devices 300a, 300b to communicate. As shown, the translator 110 receives the data 302a from the first device 300a by way of the first interface 150. The first interface 150 transmits the received data 302a to the converter 130 which processes the received data 302a and converts the received data 302a to digital data 122 at the ADC 134. Following, the FPGA 120 receives the digital data 122, and outputs translated data 124 based on the received digital data 122 to the daughter card 140. The daughter card 140 further processes the received digital data 124 and outputs processed translated data 142 to the second device 300b by way of the second interface 160. As a result, the second device 300b is capable of interpreting data 302a from the first device 300a as translated data 142 using its respective protocol.

Similarly, the communication device 100 may receive data 142 from the second device 300b. The data 142 is then translated by the translator 110 and sent to the first device 300a as data 302a supporting the first protocol. In this case, the communication device 100 receives data 142 from the second device 300b and translates the message 142 from the second communication protocol to the first communication protocol supported by the first device 300a, allowing the two devices 300a, 300b to communicate. As shown, the translator receives the message 142 from the second device 300b via the second interface 160. The second interface 160 transmits the message 142 to the daughter card 140 which processes the data 142 before transmitting the processed data 124 to the FPGA 120. The FPGA 120 translates the received data 124 before transmitting the translated data 122 to the converter 130. At the converter 130, the DAC 132 converts the translated data 122 received from the FPGA 120 to analogue data 320a which is transmitted to the first device 300 by way of the first interface 150. As a result, the first device 300a is capable of interpreting data142 from the first device 300a as translated data 302a using its respective protocol.

Referring to FIGS. 2 and 3A, in some implementations, where the translator 110 includes at least two converters 130, 130a–130n and at least two daughter cards 140, 140a–140n. The communication device 100 translates between any one of the devices 300, 300aa–300bn to any other one of the devices 300, 300aa–300bn. For example, the translator 110 translates between a first device 300, 300aa connected to a first converter 130a by way of a first first-interface 150, 150a and a second device 300, 300an connected to a second converter 130, 130n by way of a second first-interface 150, 150n. Additionally, the communication device 100 allows for translation between the first device 300, 300aa sending data 302a that is received by the communication device 100 and translated to be outputted to the remainder of the connected devices 300, 300ab–300an, 300ba–300bn. In other words, the translator 110 can receive data being in a first protocol from any one of the attached devices 300, 300aa–300bn and simultaneously translate the received data to the rest of the connected devices 300, 300aa–300bn. Therefore, the communication device 100 is very flexible allowing multiple devices 300, 300aa–300bn having respective protocols to share information.

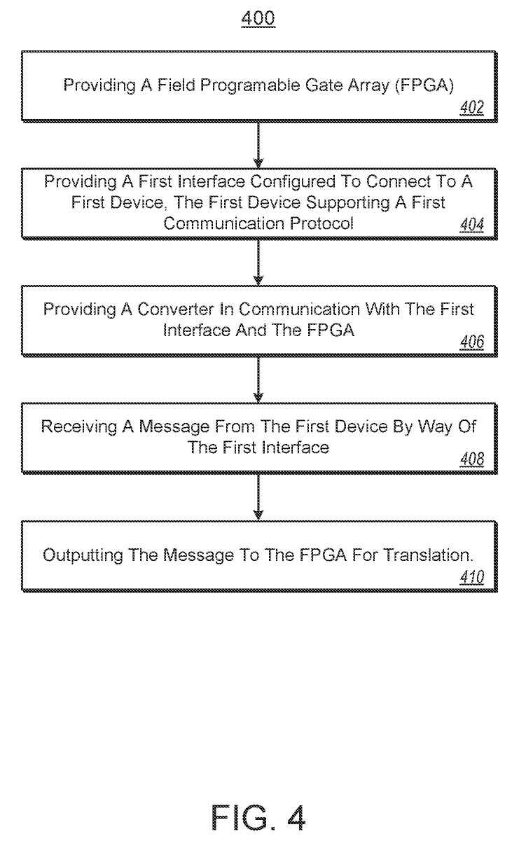

FIG. 4 provides an example arrangement of operations for a method 400 of translating communication messages between two or more devices, where each device supports a respective communication protocol using the system described in FIGS. 1–3B. At block 402, the method 400 includes providing a Field Programable Gate Array (FPGA) 120. At block 404, the method 400 includes providing a first interface 150 configured to connect to a first device 300. The first device 300 supports a first communication protocol. At block 406, the method 400 includes providing a converter 130 in communication with the first interface 150 and the FPGA 120. The converter 130 includes a digital-to-analogue converter (DAC) 132 and an analogue-to-digital converter (ADC) 134. At block 408, the method 400 includes receiving, at the converter 130, a message 302a from the first device 300 by way of the first interface 150. Additionally, the method 400, at block 410, includes outputting, from the converter 130, a processed message 122 to the FPGA for translation, where the processed message 122 is processed by the converter 130.

In some implementations, the method 400 includes receiving, at the FPGA 120, the converted message 122 from the converter 130 in a first protocol and processing, at the FPGA 120, the converted message 122. Additionally, the method 400 also includes outputting, from the FPGA 120, a processed message 124 being in a second protocol. The method 400 may also include providing a second interface 160 in communication with the FPGA 120. The second interface 160 is configured to connect to a second device 300b supporting a second communication protocol different from the first communication protocol. The method 400 may also include receiving, at the FPGA 120, a message from a daughter card in the second communication protocol. The daughter card 140 positioned between the FPGA 120 and the second interface 160. The method 400 also includes processing, at the FPGA 120, the received message 124 from the daughter card 140, and outputting, from the FPGA 120, a processed message 122 to the converter 130, where the processed message 122 is in the first communication protocol.

In some examples, when the converter 130 receives a processed message from the FPGA 122, the DAC 132 converts the processed message 122 to an analogue message 302a, and when the converter 130 receives the message 302a from the first device 300a, the ADC 134 converts the message to a digital message 122.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A communication device for translating messages between at least two devices, each device supporting a respective communication protocol, the communication device comprising:
a Field Programable Gate Array (FPGA);
a first interface configured to connect to a first device, the first device supporting a first communication protocol;
a converter in communication with the first interface and the FPGA, the converter comprising:
a digital-to-analogue converter (DAC), and
an analogue-to-digital converter (ADC);
wherein the converter receives a message from the first device by way of the first interface, then outputs a converted message to the FPGA for translation.

2. The communication device of claim 1, wherein the FPGA:
receives the converted message from the converter in a first protocol,
processes the converted message, and
outputs a processed message, the processed message being in a second protocol.

3. The communication device of claim 1, further comprising:
a daughter card in communication with the FPGA; and
a second interface in communication with the FPGA, the second interface configured to connect to a second device, the second device supporting a second communication protocol different from the first communication protocol.

4. The communication device of claim 3, wherein the FPGA:
receives a message from the daughter card in the second communication protocol,
processes the received message, and
outputs a processed message to the converter, the processed message being in the first communication protocol.

5. The communication device of claim 1, wherein:
when the converter receives a processed message from the FPGA, the DAC converts the processed message to an analogue message; and
when the converter receives the message from the first device, the ADC converts the received message to a digital message.

6. The communication device of claim 1, wherein during a configuration phase, the FPGA is connected to a computing device, the computing device is configured to program the FPGA to translate messages from the first communication protocol to a second communication protocol and vice versa.

7. A method for translating communication between at least two devices, each device supporting a respective communication protocol, the method comprising:
providing a Field Programable Gate Array (FPGA);
providing a first interface configured to connect to a first device, the first device supporting a first communication protocol;
providing a converter in communication with the first interface and the FPGA, the converter comprising a digital-to-analogue converter (DAC) and an analogue-to-digital converter (ADC);
receiving, at the converter, a message from the first device by way of the first interface; and
outputting, from the converter, a converted message to the FPGA for translation.

8. The method of claim 7, further comprising:
receiving, at the FPGA, the converted message from the converter in a first protocol;
processing, at the FPGA, the converted message; and
outputting, from the FPGA, a processed message, the processed message being in a second protocol.

9. The method of claim 7, further comprising:
providing a second interface in communication with the FPGA, the second interface configured to connect to a second device, the second device supporting a second communication protocol different from the first communication protocol.

10. The method of claim 9, further comprising:
receiving, at the FPGA, a message from a daughter card in the second communication protocol, the daughter card in communication with the FPGA and the second interface;
processing, at the FPGA, the received message; and
outputting, from the FPGA, a processed message to the converter, the processed message being in the first communication protocol.

11. The method of claim 7, wherein:
when the converter receives a processed message from the FPGA, the DAC converts the processed message to an analogue message; and
when the converter receives the message from the first device, the ADC converts the message to a digital message.

12. The method of claim 7, wherein during a configuration phase, the FPGA is connected to a computing device, the computing device is configured to program the FPGA to translate messages from the first communication protocol to a second communication protocol and vice versa.
